(19) United States
(12) Patent Application Publication
(10) Pub. No.: US 2013/0341884 A1
(43) Pub. Date: Dec. 26, 2013

(54) ORTHOPEDIC MOBILITY DEVICE

(71) Applicant: Thomas Raphael, Winchester, MA (US)

(72) Inventor: Thomas Raphael, Winchester, MA (US)

(21) Appl. No.: 13/956,675

(22) Filed: Aug. 1, 2013

Related U.S. Application Data
(63) Continuation-in-part of application No. 13/588,199, filed on Aug. 17, 2012, now Pat. No. 8,523,213.
(60) Provisional application No. 61/525,338, filed on Aug. 19, 2011.

(51) Int. Cl. B62M 1/38; B62K 15/00

(52) U.S. Cl. CPC B62M 1/38; B62K 15/008
USPC 280/259; 280/274

(57) ABSTRACT

An adult scale three-wheeled device facilitates movement for mobility challenged persons. The device is foot propelled while seated either through walking while seated or pedaling. The device is provided with a limited footprint for navigating confined areas while the individual is seated in a substantially standing position, with the pedals being repositionable so as to allow unobstructed walking while remaining seated. A lockable braking system prevents one or more wheels from turning. The device is collapsible for storage.

### RELATED APPLICATION

This application is a Continuation-In-Part of U.S. patent application Ser. No. 13/588,199, entitled Orthopedic Mobility Device, filed on Aug. 17, 2012, and which claims the benefit of U.S. Provisional Patent Application Ser. No. 61/525,338, entitled “A foldable adult tricycle for mobility, exercise and rest support for those with joint problems”, filed on Aug. 19, 2011, the contents both of which are incorporated herein by reference in their entireties for all purposes.

### BACKGROUND

1. Technical Field

This invention relates to the field of adult mobility devices. A field that includes devices such as wheelchairs and strollers designed to provide a physical assist to individuals moving from one location to another.

2. Background Information

It is well recognized that there is a societal need for devices that provide a physical assist to human movement. The earliest known human riddle queries what creature moves on three legs in the evening. The answer to the Sphinx's riddle is man and the third leg: a cane.

Whether as a result of age, disability or disease many people find a need for assistance in moving from one location to another. Numerous devices have been designed to address this need: from the simple cane or walking stick to motorized wheelchairs.

The need for mobility assistance is specific depending on the limitations of the individual. Consequently the solution must be specifically tailored to the individual circumstances it seeks to address. A wheelchair is inappropriate for someone who requires a cane, and a cane is inappropriate for someone who requires a wheelchair.

Walkers have become a common solution for people who require more support than a single point support, such as a cane, can provide but who are still mobile enough to walk. Additionally there is a physical and psychological benefit to maintaining physical exercise and independence. However some people, because of their physical condition, require more support than that provided by walker while still requiring less than that provided by a wheelchair. Many people who are effected by joint problems (such as problems with the back, hip, knee or foot), heart limitations, or who tire easily may have the use of their legs but due to discomfort or energy level require frequent or constant support to relieve parts of their body from carrying their full weight. There is therefore a need for a device that will substantially support a person's weight, and at the same time provide them with the capacity to propel themselves with their legs as well as their arms. A device such as a walker provides stability but little weight support. A wheelchair provides substantial physical support but provides little ability to propel oneself with their legs. This application presents an inventive solution that addresses this societal need.

### SUMMARY

Tricycles traditionally have found extensive use as a children's toy. They are designed low to the ground and with relatively widely splayed rear wheels. This provides a low center of gravity and great stability. However the design that benefits a child proves unworkable for an adult, particularly inside a residence, due to the dimensions of an adult scaled version. It is also unworkable for someone who has mobility problems because of its low seat position.

One aspect of the present invention provides a three-wheeled device (tricycle) designed to provide improved mobility for people who are physically challenged through some condition such as age, infirmity, disability or disease. The adult sized three-wheel device is designed to support a seated adult in a substantially standing position while maintaining a limited footprint. The “footprint” is defined as the two dimensional surface area covered by device and defined at its outer boundary by the points where the device contacts the surface (such as a floor). A “limited footprint” in the context of this application is defined as a footprint restricted in size by a fixed ratio.

In another aspect of the invention the tricycle provides pedals that may be used to propel the tricycle. These pedals may be repositionable or removable so as not to interfere with the user walking the device. “Walking the device” refers to moving the vehicle by using the feet to exert a force directly against the ground while remaining seated, causing the device to move.

In another aspect of the invention the tricycle is collapsible for convenience of storage or transport. The device may also incorporate parts such as the seat, handlebars, pedals, and wheels, which may be adjusted or removed. This provides for additional storage flexibility by disassembly as well as providing for the use of interchangeable parts for different operating situations.

### BRIEF DESCRIPTION OF THE DRAWINGS

FIG. 1 is a perspective view of one aspect of the present invention.

FIG. 2 is a perspective view of one aspect of the present invention manipulated for easy storage.

FIG. 3 is a schematic view of a pedal assembly.

FIG. 4 is a perspective view of the steering element with phantom lines representing alternate positioning.

FIG. 5 is a top schematic view of a footprint created by the surface contact points of three wheels.

FIG. 6 is a side schematic view of seat height relative to the distance between two wheels.

FIG. 7 is a perspective view of an alternate embodiment of the present invention.

FIG. 8 is a perspective view of another embodiment of the present invention.

FIG. 9 is a perspective view, on an enlarged scale, of a portion of the embodiment of FIG. 8, with portions thereof shown in phantom to indicate optional movement.

FIG. 10 is a cross-sectional view taken along 10-10 of FIG. 9.

FIG. 11 is a side elevational view of an embodiment that employs the optionally movable aspect of FIG. 9.

FIG. 12 is a front elevational view of the embodiment of FIG. 11, with brake portions shown in an engaged orientation.

FIG. 13 is a view similar to that of FIG. 12, with brake portions shown in a disengaged orientation.

### DETAILED DESCRIPTION

In the following detailed description, reference is made to the accompanying drawings that form a part hereof, and in which is shown by way of illustration, specific aspects in which the invention may be practiced. These aspects are described in sufficient detail to enable those skilled in the art to practice the invention, and it is to be understood that other aspects may be utilized. It is also to be understood that structural, procedural and system changes may be made without departing from the spirit and scope of the present invention. In addition, well-known structures and techniques have not been shown in detail in order not to obscure the understanding of this description. The following detailed description is, therefore, not to be taken in a limiting sense, and the scope of the present invention is defined by the appended claims and their equivalents.

### General Overview

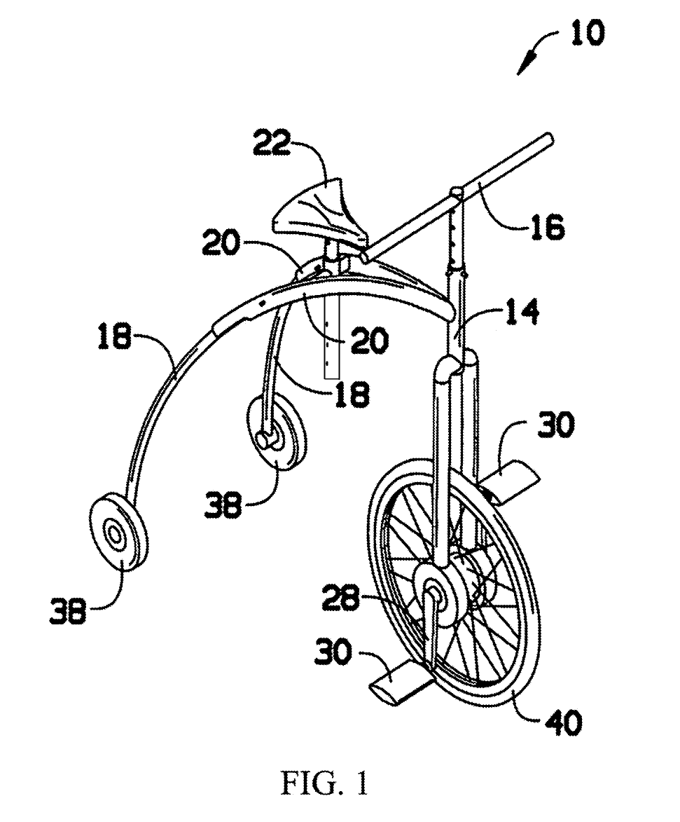

Aspects of the present invention include an adult tricycle 10 as in FIG. 1 comprising a front frame 14 that is connected to a wheel 40. The wheel 40 is connected to a pedal 30 on each side of the wheel 40 by a connecting bars 28. This pedal wheel assembly attached to the frame 14 allows the vehicle to be propelled by applying pressure to pedals 30 resulting in torque on the connecting bars 28 which rotate the wheel 40. The steering element 16 is connected to the wheel assembly so that rotation of the steering element 16 causes a rotational force to be applied perpendicular to the axis of the wheel 40 causing a change in direction of the vehicle's 10 movement.

The seat 22 is supported by a seat-supporting element 20 that couples the front frame 14 to the rear wheel-connecting elements 18. These rear wheel-connecting elements 18 are in turn supported by the rear wheels 38. It should be noted that, although this aspect represents the seat-supporting element 20 as connecting to two separate wheel-connecting elements 18, this is not to be viewed as a design restriction. In another aspect the wheel-connecting elements 18 may be connected to a rear frame, the rear frame then connecting to the seat-supporting element. Moreover, it should be recognized that seat-supporting element 20 may be either rigidly, or hingedly, coupled to front frame 14, depending on the particular application. A rigid configuration, as shown, may be desired for simplicity and low cost. A hinged coupling may permit the seat-supporting element 20 to be rotated into a folded position in which it extends substantially parallel to the front frame 14, for enhanced compactness when folded.

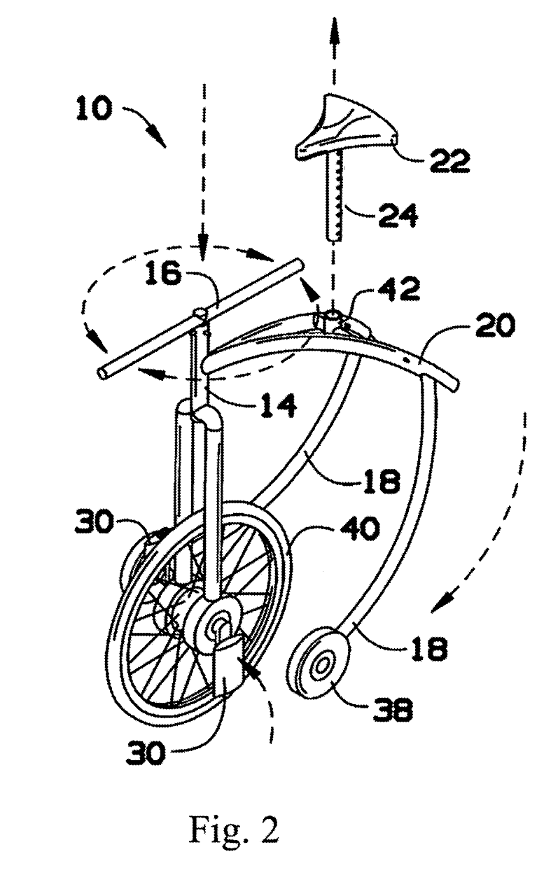

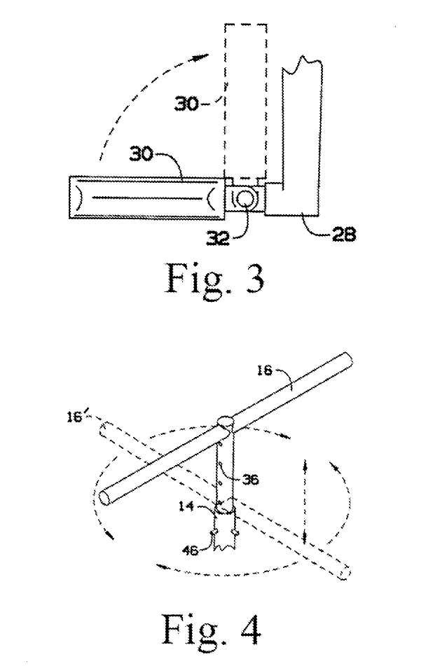

As seen in FIG. 2, in one aspect of the invention the vehicle 10 is collapsible and includes easily removable parts. In this aspect the connection between the rear wheel-connecting elements 18 and the seat-supporting element 20 are hinged allowing the rear wheels 38 and wheel-supporting elements to rotate downward and inward relative to the seat-supporting element 20 so that the distance from the rear wheels 38 and the front wheel 40 is reduced, but also the distance between the two rear wheels 38 is reduced, when in the collapsed position. It is also shown in this aspect that a seat-supporting post 24 is removable from a seat supporting sleeve 42, the sleeve 42 being a part of, or integrally coupled to, the seat-supporting element 20. Furthermore the pedals 30 may be folded inwards (see FIG. 3 description to follow). The steering element 16 may also be uncoupled from the front frame 14 and moved independently (See FIG. 4 description to follow).

As seen in FIG. 3, in one aspect of the invention the pedal assembly is shown. The connecting bars/rods 28 is attached to the pedal 30 by means of a hinge 32. This hinge allows for the pedal 30 to be folded inwardly into a position shown in phantom lines, i.e., so that the pedals lie within a plane substantially parallel to the plane of the wheel 40 as shown in FIG. 2. These folding pedals provide for easier storage. In addition, the pedals 30 may be maintained in the folded position to permit a user to walk the vehicle without the pedals obstructing the motion of the user's feet.

As seen in FIG. 4, in one aspect of the invention the steering element 16 is shown. In this aspect, the steering element includes a substantially horizontal bar and a vertical bar configured for slidable receipt within a sleeve disposed at the top of the front frame 14. Holes 36 may be provided so that removable pins 46 may be inserted or removed to rigidly couple or uncouple the steering element 16 from the front frame 14 allowing for ease of storage or interchangeable steering elements. It should be recognized that the flat steering element 16 is merely exemplary, and that any number of handlebar configurations known to those skilled in the art of bicycle fabrication, may be used without departing from the scope of the present invention. In addition, the steering element may be folded backwards or downwards for ease of storage, such as shown in phantom at 16′ in FIG. 4.

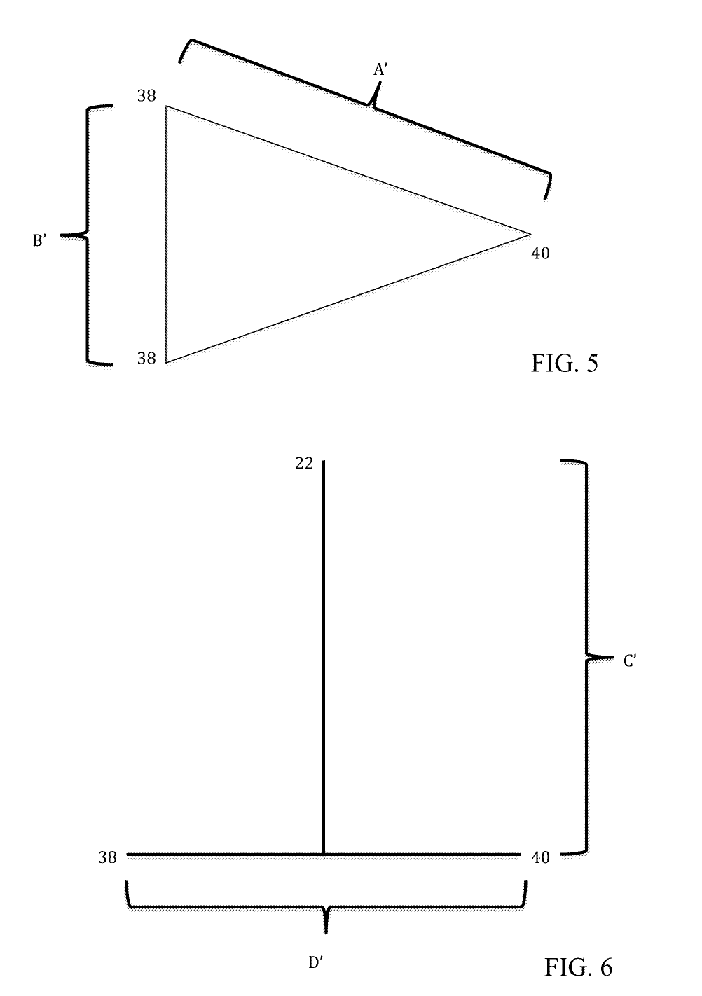

As seen in FIG. 5, a footprint of device 10 is defined by lines connecting the surface contact points of the front wheel 40 and two rear wheels 38 when in the deployed configuration of FIG. 1. The distance A′ between the front wheel 40 and a rear wheel 38 is shown as well as the distance B′ between the two rear wheels 38.

As seen in FIG. 6, dimensions of device 10 as shown from a substantially elevational perspective include the relative height C′ of seat 22 (FIG. 1) and the distance D′ between the two wheels furthest apart from one another (i.e., between wheel 40 and a wheel 38 in the embodiment shown).

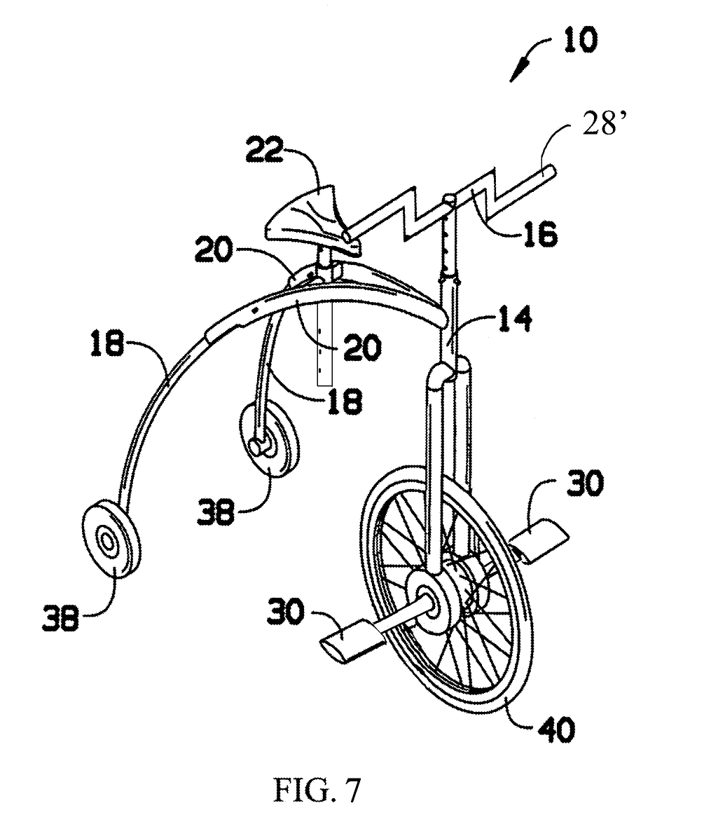

As previously mentioned the embodiments described hereinabove should be viewed in an illustrative rather than limiting sense. Moreover, in a variation of the foregoing, the pedals may be entirely removable or an additional feature such as a clip, detent, or other fastener may be included to conveniently hold them in a folded position. Moreover, rather than being disposed on the front steering wheel 40 as shown, the pedals may be rotatably disposed on a bracket on the frame, and connected via conventional chain drive, belt, or drive shaft, to a (for example, rear) drive wheel. Still further, it is contemplated that the connecting bars 28 and pedals 30 may be eliminated and replaced by a hand crank located at the position of steering element 16, such as shown in FIG. 7 at 28′, to effectively form a combined steering/drive element. The hand crank may be coupled via chain drive, belt, or drive shaft, etc., (not shown) to drive the wheel 40. Thus, the user may propel the vehicle by use of the hands rather than the feet. In this aspect a platform or bar may be employed to support the user's feet. This resting bar for example might include a horizontal bar extending from the axle of the front wheel.

In yet another aspect parts may be interchangeable to allow for customization for a particular user. Different styles and shapes of handlebars, seats, pedals and wheels may be employed. For example handlebars customized to provide additional resting support might be used. Wheels might be exchanged depending on the terrain (i.e. indoor use as opposed to outdoor use. The seat might be exchanged for one design or another depending on whether it is being used for exercise or relaxation.

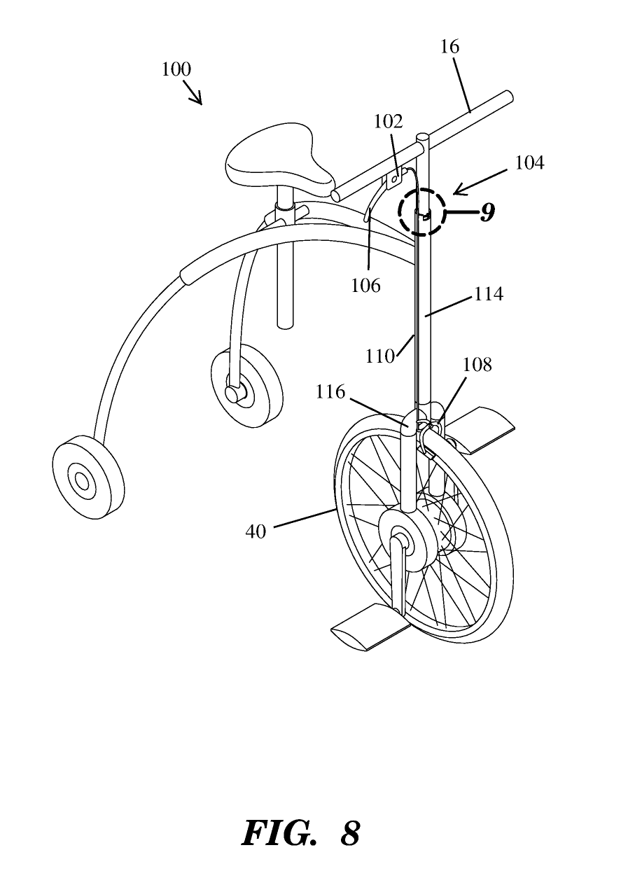

In yet another aspect a brake system may be employed allowing for the slowing or stopping of the vehicle. Furthermore these brakes may be fixed in the locked position rendering the vehicle immobile and increasing its stability. The braking system may be connected to one or more wheels and may use various technologies such as cable driven mechanical systems (such as shown and described hereinbelow with respect to FIG. 8) or any alternative performing substantially the same function such as a remote electrical or motorized system. The brake may further be either a hand operated brake, a foot operated brake or any combination thereof.

In yet another aspect the arrangement of the wheels may be reconfigured. One example of this might be a reverse tricycle arrangement with two wheels in front of the seated user and one wheel behind. The device might also employ more than three wheels such as a quadricycle design utilizing four wheels. Additional wheels might be employed for added support.

The present invention thus provides a multi-wheeled mobility device for use by adults for whom movement is otherwise difficult. It provides a self-propelled vehicle that provides the added support of a seat and the stability of at least three wheels usable in various environments. Those environments may include, but are not limited to: malls, sidewalks, hallways and interior residential areas.

In particular aspects the vehicle has a limited footprint, e.g., an area defined by the ground-engaging contact points (or geometric centers) of its wheels. The size of this footprint may be restricted to an area and shape that will allow maneuvering in the interior residential floor spaces typically navigated by a walking adult. Walking in this context is generally defined as the normal unobstructed bipedal directional movement and turning of an individual.

In a particular aspect, the limited footprint may be defined in terms of an aspect ratio between the height C′ of the seat 22 and the distance D′ between the geometric centers of the two wheels located furthest from one another as shown in FIGS. 5-6. In FIG. 5 the distance A′ is shown as greater than B′ so in FIG. 6, for the purpose of determining the height to length ratio, the distance D′ would correspond to the distance A′ in FIG. 5. In an alternate aspect the distance B′ might be longer than A′ in which case B′ would correspond to D′ in FIG. 6. In particular aspects, the aspect ratio is at least 1:1, and may be as high as 2.5:1. In particular applications, the aspect ratio may be in a range of about 1.25:1 to 2:1.

This description of a limited footprint need not be construed to be limited to three wheels. In a further aspect more than three wheels may be employed, e.g., in which the aspect ratio is defined as the ratio of seat height to the distance between the geometric centers of the two wheels located furthest from one another.

In various other aspects numerous features may be incorporated into the vehicle. In yet another aspect the vehicle may comprise a noise-producing device such as a bell to alert people to the users presence. The vehicle may comprise a light for illumination or to notify people of the user's presence at night. The vehicle may also comprise an orientation sensitive mechanism to provide an alert if the vehicle tips beyond a preset threshold. The vehicle may also comprise a basket for transporting various personal items or groceries. A further feature may be a handle or push pad allowing a third party to assist the user up an incline or provide added stability by holding onto or pushing the vehicle.

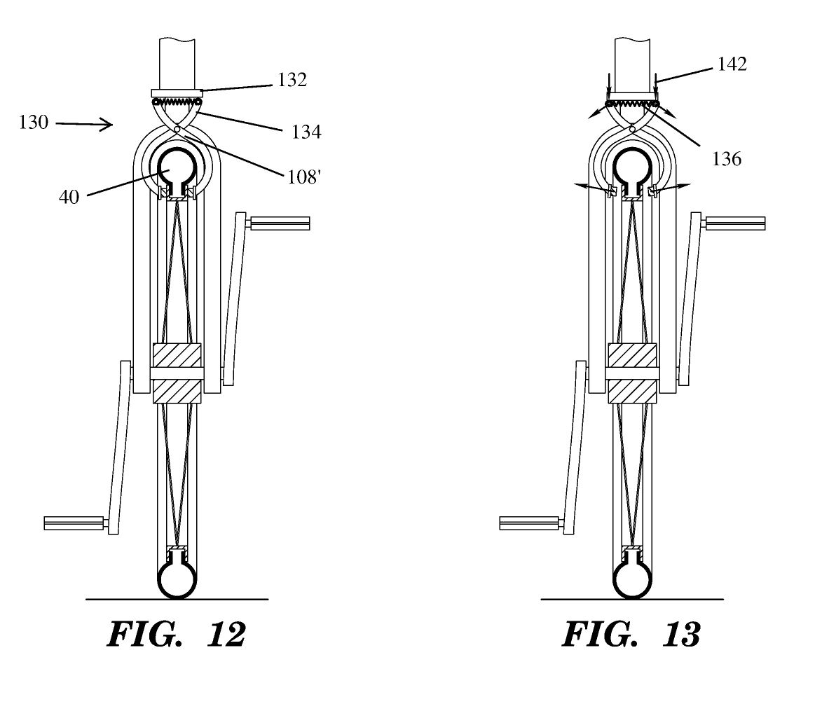

Turning now to FIGS. 8-13, additional implementations of the invention will be shown and described. As shown in FIG. 8, a mobility device 100 which is otherwise similar to device 10 described hereinabove, may be equipped with a handbrake 102 and/or an automatic limited turning radius device 104. In the example shown, handbrake 102 may be a conventional cable actuated bicycle brake, including a hand actuatable lever 106 operatively engaged with a brake caliper 108 via cable 110. Actuation of lever 106 serves to compress the caliper 108, which is mounted on fork 116, into engagement with the wheel 40 to effect braking in a conventional manner. And although a caliper 108 is shown, it should be recognized that any number of alternate approaches may be used, such as conventional disk brakes or drum brakes, or other types of brakes that may be developed in the future for bicycles and other vehicles.

The handbrake 102 may thus be applied by squeezing the lever 106 which causes the brake pads to be pressed against the rim of the rotating wheel, to slow and then stop the rotation. The handle may also be locked in a conventional manner, to keep the wheel from rotating when the user releases the lever 106. This approach may be conveniently used by relatively agile users.

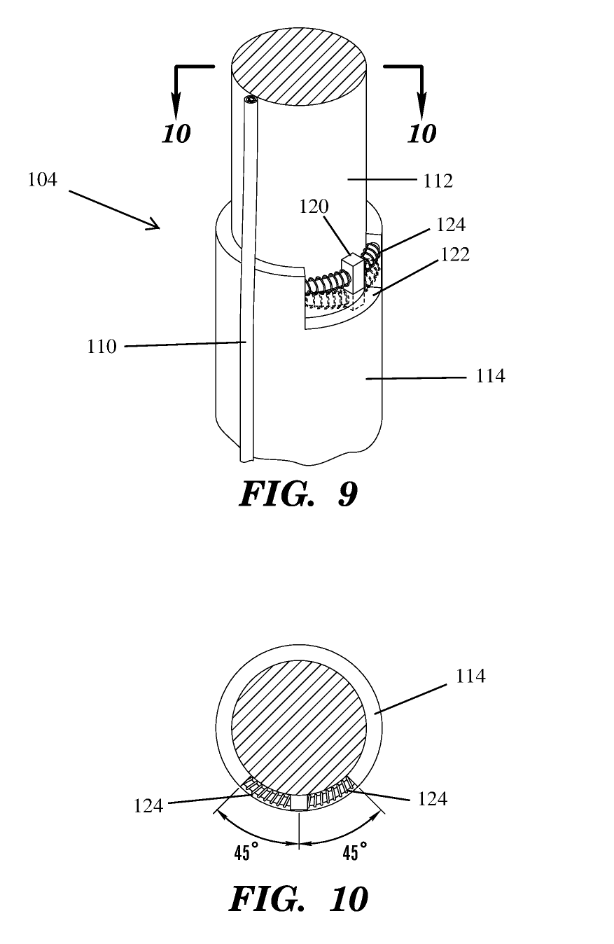

Referring to FIGS. 8-10, automatic limited turning radius device 104 is configured to limit the turning radius of the vehicle 100, while also providing a bias that tends to return the handle bars 16 to the center position. In the particular example shown, steering is accomplished in a conventional manner, with a handlebar stem 112 that slidably passes through a head tube 114 portion of front frame 14, to rigidly connect handlebar 16 to the front fork 116. The stem 112 thus rotates within the head tube 114 when the user turns the handlebars 16 to turn the fork 116 and steer the vehicle. As best shown in FIGS. 9 and 10, the stem 112 is provided with an abutment 120 which is received within a notch (cut-out) 122 portion of head tube 114. The edges of the notch 122 serve as stops to limit the turning radius of the vehicle, e.g., to 45 degrees on either side of center, as shown in FIG. 10. And while 45 degrees to either side of center (straight) is shown and described, it should be recognized that substantially any limit may be used, depending on the particular application. For example, in some implementations a turning radius as small as 10 degrees on either side of center may be desired, while in others, 60 degrees or more may be suitable.

As also shown, bias elements 124, e.g., in the form of springs, as shown, may be disposed on opposite sides of abutment 20, between the abutment and the edges of notch 122. In the particular example shown, bias elements 124 may be coil springs wound around a flexible guide that extends slidably through the abutment 120, between the edges of notch 122. When the user turns the handlebars 16, the abutment 120 compresses one of the springs against its bias. When the turning has been completed, the bias of the compressed spring helps to return the handlebars 16 and fork 116 to the center/straight position. Thus, in this example, the spring loading will help hold the steering to straight ahead until turned by the user, and may then help to automatically return the steering to the straight ahead position if let go by the user.

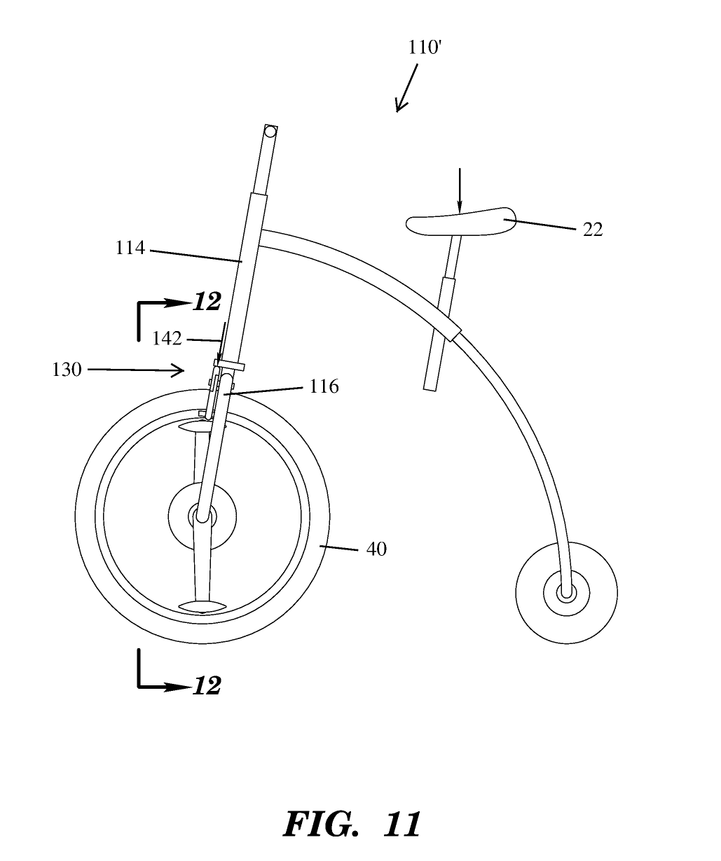

Moreover, in particular implementations, stem 112 may be configured to move axially within head tube 114, e.g., to move abutment 120 into the position shown in phantom in FIG. 9, as will be discussed in greater detail with respect to FIGS. 11-13.

Turning now to FIGS. 11-13 an embodiment shown as vehicle 110′ is substantially similar to vehicles 10 and 110, but for the following variations. As shown, vehicle 110′ may include an automatic (e.g., reverse-acting) brake 130, configured to automatically engage when the user is not on the seat 22. This automatic brake 130 feature may take any number of forms, such as an electronic (e.g., ultrasonic) proximity sensor to detect the presence of the user, to actuate an electrically operated brake. Alternatively, automatic brake 130 may be a relatively simple mechanical device, as shown, including a flange 132 on head tube 114, disposed to engage and spread a pair of upper caliper arm portions 134 against the bias of a spring 136 to disengage the wheel when a user is seated on the vehicle. In operation, when a user applies weight to the seat 22, such as shown at 140 in FIG. 11, head tube 114 moves downward relative to stem 112 and fork 116 as shown at 142 of FIGS. 11 and 13. When so moved, the flange 132 engages and spreads the upper arm portions 134 of (fork-mounted) brake caliper 108′, against the bias of spring 136 to disengage the wheel as shown in FIG. 13. When the user dismounts from seat 22, the bias of spring 136 contracts the arm portions 134 (raising the head tube 114 relative to fork 116 and stem 112, e.g., into the position shown in phantom in FIG. 9) so that caliper 108′ engages the wheel. In this manner, the reverse acting bicycle brake 130 is normally on, and locks the front wheel while vehicle 110′ is unmanned or not bring operated. This implementation may be particularly useful to disabled or elderly users, to reduce the chance of accidental movement of the vehicle 110′ when mounting or dismounting, and/or of free-rolling away from the user.

It should be further understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. An orthopedic mobility device comprising:
a front frame element having at least one front wheel rotatably mounted thereto;
said front wheel communicably coupled by an elongated member to a steering element;
said front frame element including a head tube connected to a rear frame element by a seat supporting element; said rear frame element having at least two wheels rotatably mounted thereto;
said seat supporting element supporting a seat that maintains an adult in a near standing position; and
the front and rear wheels being positioned so as to create a limited footprint allowing maneuverability of said device indoors;
said limited footprint being defined by an aspect ratio of a seat height to a greatest distance between geometric centers of any two of the wheels, said aspect ratio being at least 1.1:1; and
the steering element including a limited turning radius device having stops configured to limit the turning radius of the orthopedic mobility device to predetermined positions on either side of a center position, while also including a bias element configured to bias the steering element towards the center position.

2. The orthopedic mobility device of claim 1, wherein the steering element includes a handlebar stem configured to rotate within the head tube, and the limited turning radius device includes an abutment disposed on the handlebar stem, the abutment configured for receipt within a notch portion of the head tube with edges of the notch portion forming the stops.

3. The orthopedic mobility device of claim 1, wherein the stops are disposed within a range of 10 to 60 degrees on either side of the center position.

4. The orthopedic mobility device of claim 1, wherein the bias element comprises at least one spring disposed between the abutment and one of the stops.

5. The orthopedic mobility device of claim 4, wherein the bias element comprises a spring disposed between the abutment and each of the stops.

6. The orthopedic mobility device of claim 1, further comprising an automatic brake configured to automatically engage when the user is not on the seat, and to automatically disengage when the user is on the seat.

7. The orthopedic mobility device of claim 6, wherein the automatic brake comprises a flange on the head tube, the flange disposed to move axially with the head tube relative to the stem, so that the flange is configured to engage and spread a pair of upper caliper arm portions against the bias of a spring to alternately disengage a wheel when a user is seated on the vehicle, and engage the wheel when the user dismounts from the seat.

8. The orthopedic mobility device of claim 1, further comprising:
said seat supporting element including a left seat support and a right seat support, the left and right seat supports extending in a splayed orientation from the head tube towards the rear frame element and terminating, respectively, at left and right hinges;
a cross-bar extending between the left and right seat supports at a location between the head tube and the left and right hinges; and
the rear frame element including a left wheel support hingedly coupled to the left hinge, and a right wheel support hingedly coupled to the right hinge, wherein said at least left and right rear wheels are configured to rotate relative to the front frame element and fold into a final position closer to the front frame element than in an unfolded position.

9. The orthopedic mobility device of claim 1, wherein said aspect ratio is within a range of at least 1.25:1 and up to 2:1.

10. The orthopedic mobility device of claim 1 wherein the device is a tricycle comprising one steering wheel and two non-steering wheels.

11. The orthopedic mobility device of claim 10 wherein at least one wheel is communicably coupled to pedals allowing a user to propel the device by pedaling.

12. The orthopedic mobility device of claim 11 wherein the pedals may be repositioned so as not to interfere with walking the device.

13. The orthopedic mobility device of claim 12 wherein the device is foldable wherein the rear frame element is hinged in at least one location so as to permit the rear wheel to rotate relative to the front frame element and fold into a final position closer to the front frame element than in the unfolded position.

14. The orthopedic mobility device as of claim 13, wherein the device is foldable between deployed and folded positions, wherein rear wheels are disposed closer to the front wheel and to each other in the folded position than in the deployed position.

15. The orthopedic mobility device of claim 14 where a part selected from a group consisting of pedals, seats, steering elements, and wheels is removable.

16. The orthopedic mobility device of claim 15, further comprising a brake connected to at least one wheel, said brake being lockable so as to prevent movement of said wheel.

17. The orthopedic mobility device of claim 10 where the steering element comprises a hand crank communicably coupled with at least one wheel allowing a user to propel the device with hands.

18. The orthopedic mobility device of claim 1 where the footprint has a shape of an isosceles triangle with a base of 1.3 feet to 2 feet and a height of 1.3 feet to 2.5 feet.

19. A method for providing mobility assistance to an adult, said method comprising:
(a) providing the orthopedic mobility device of claim 1;
(b) locking the brakes so that the vehicle is immobile;
(c) enabling the adult to sit on the device;
(d) enabling the adult to choose whether to propel the device with pedals or by walking the vehicle while seated;
(e) selectively placing the pedals in one orientation for pedaling the device, and in another orientation for walking the device; and
(f) unlocking the brakes so that the vehicle is mobile.

20. The method of claim 19, further comprising selectively folding and unfolding the device for storage and mobile operation, respectively.

21. The method of claim 20, further comprising selectively exchanging the wheels for different operating conditions.

22. The method of claim 21, further comprising configuring an orientation sensitive alarm to provide an alert if the vehicle tips beyond a predetermined threshold.
